(19) United States
(12) Patent Application Publication
(10) Pub. No.: US 2013/0334898 A1
(43) Pub. Date: Dec. 19, 2013

(54) AC POWER SYSTEMS FOR POWERING CORDLESS POWER TOOLS

(71) Applicant: Standard Cable USA, Inc., Rancho Santa Margarita, CA (US)

(72) Inventors: Selvin Kao, Ladera Ranch, CA (US); Philip Carlo J. DeGuzman, Fontana, CA (US)

(21) Appl. No.: 13/918,662

(22) Filed: Jun. 14, 2013

Related U.S. Application Data
(60) Provisional application No. 61/660,629, filed on Jun. 15, 2012.

(51) Int. Cl. H02M 7/02

(52) U.S. Cl. CPC H02M 7/02
USPC 307/151

(57) ABSTRACT

Alternating current power systems for powering cordless power tools are disclosed. An electrical power assembly comprises an alternating current to direct current (“AC/DC”) converter connected to a power interface adapter. The AC/DC converter receives alternating current through an electrical socket and generates direct current. A power interface adapter shaped similarly to the replacement battery packs is connected to the cordless power tools and feeds the direct current to the cordless tool. The AC/DC converter may be located within the power interface adapter or a wall-mountable electrical connector.

### RELATED APPLICATIONS

This application relates to, claims priority from, and incorporates herein by reference, as is fully set forth by U.S. Provisional Patent Application Ser. No. 61/660,629 filed on Jun. 15, 2012 and entitled “DC BATTERY REPLACEMENT AC POWER SUPPLY.”

### BACKGROUND OF THE INVENTION

1. Field of the Invention

The present invention relates in general to power tools. More particularly, the invention is directed to power adapters for cordless power tools.

2. Description of the Related Art

Cordless power tools provide several advantages over traditional, corded tools such as offering increased convenience and mobility, as well as the ability to work at jobsites which do not have electrical power. However, in heavy-duty applications, the battery packs of the cordless power tools are rapidly drained. As such, users must either purchase multiple battery packs or use conventional corded power tools.

Accordingly, a need exists to provide power to cordless power tools employed in heavy-duty applications.

### SUMMARY OF THE INVENTION

In the first aspect, an electrical power assembly is disclosed for powering a cordless power tool configured for coupling to replaceable battery packs. The electrical power assembly comprises a power interface adapter configured for mating with and providing direct current to the cordless power tool. The power interface adapter further comprises an alternating current to direct current (“AC/DC”) power converter, the AC/DC power converter receiving alternating current and generating direct current, one or more electrical connectors coupled to the AC/DC power converter and configured for supplying direct current to the cordless power tool, and a housing surrounding the AC/DC power converter and exposing the one or more electrical connectors for electrical contact to the cordless power tool.

In a first preferred embodiment of the electrical power assembly, the electrical power assembly further comprises an AC electrical connector for coupling to an alternating current power source and receiving alternating current, and a power cord connected to the AC electrical connector and AC/DC power converter, the power cord providing the alternating current to the AC/DC power converter. The power interface adapter preferably mates with the cordless power tool in substantially the same manner as the replaceable battery pack mates with the cordless power tool. The shape of the power interface adapter is preferably substantially similar to the shape of the battery pack. A portion of the cordless power tool preferably at least partially surrounds the power interface adapter when the power interface adapter is mated with the cordless power tool. The AC/DC power converter preferably comprises a switching power source. The AC/DC power converter preferably comprises a transformer. The power cord is preferably coupled to the power interface adapter via a swivel connector.

In a second aspect, an electrical power assembly is disclosed for powering a cordless power tool configured for coupling to replaceable battery packs. The electrical power assembly comprises a wall mountable AC/DC power converter having integrated AC electrical connectors, the AC/DC power converter receiving alternating current and generating direct current, a power cord connected to the AC/DC power converter, the power cord receiving direct current, and a power interface adapter configured for mating with and providing direct current to the cordless power tool. The power interface adapter further comprises one or more electrical connectors coupled to the power cord and configured for supplying direct current to the cordless power tool, and a housing exposing the one or more electrical connectors for electrical contact to the cordless power tool.

In a second preferred embodiment, the power interface adapter mates with the cordless power tool in substantially the same manner as the battery pack mates with the cordless power tool. The shape of the power interface adapter is preferably substantially similar to the shape of the battery pack. The cordless power tool preferably at least partially surrounds the power interface adapter when the power interface adapter is mated with the cordless power tool. The AC/DC converter preferably comprises a switching power source. The AC/DC converter preferably comprises a transformer.

In a third aspect, an electrical power assembly for powering a cordless power tool is disclosed for coupling to replaceable battery packs. The electrical power assembly comprises an AC/DC power converter, the AC/DC power converter receiving alternating current and generating direct current, and a power interface adapter configured for mating with the cordless power tool, the power interface adapter receiving the direct current from the AC/DC power converter and powering the cordless power tool.

In a third preferred embodiment, the power interface adapter mates with the cordless power tool in substantially the same manner as the battery pack mates with the cordless power tool. The shape of the power interface adapter is preferably substantially similar to the shape of the battery pack. The cordless power tool preferably at least partially surrounds the power interface adapter when the power interface adapter is mated with the cordless power tool. The AC/DC converter preferably comprises a switching power source. The AC/DC converter preferably comprises a transformer.

These and other features and advantages of the invention will become more apparent with a description of preferred embodiments in reference to the associated drawings.

### DESCRIPTION OF THE DRAWINGS

FIG. 1 is an exploded view of an exemplary cordless power tool.

FIG. 2 is a side, perspective view of an electrical power assembly having a power interface adapter with an internal AC-DC converter in an embodiment.

FIG. 3 is another side, perspective view of the electrical power assembly showing the electrical contacts and the mating tab on the power interface adapter.

FIG. 4 is a side, perspective view of a cordless power tool coupled with the electrical power assembly depicted in FIGS. 2 and 3.

FIG. 5 is a side view of an electrical power assembly having the AC-DC converter within a wall mountable electrical plug in an embodiment.

FIG. 6 is a front, perspective view of the electrical power assembly having the AC-DC converter with the wall mountable electrical plug.

FIG. 7 is a side, perspective view of the cordless power tool coupled with the electrical power assembly depicted in FIGS. 5 and 6.

### DETAILED DESCRIPTION OF THE PREFERRED EMBODIMENTS

The following preferred embodiments are directed to alternating current (“AC”) power systems for powering cordless power tools. Most cordless power tools are powered using direct current (“DC”) from rechargeable battery packs which snap into and mechanically engage with the bodies of the power tools. However in the field, a fully charged battery pack may not have sufficient capacity to complete a job. As such, contractors and other users would normally purchase several DC replacement battery packs which may be alternately used while the others are charging.

One or more embodiments provide a temporary replacement to the conventional battery pack. In one or more embodiments, electrical power assemblies may be plugged in directly to any AC wall socket and may have a power interface adapter shaped as a replaceable battery pack to mate with the power tool. In an embodiment, the AC/DC power converter is located inside the power interface adapter and is powered by a power supply cord connected to an AC plug. The power interface adapter is attached directly into the main power tool. The AC/DC power converter located inside the power interface adapter is equipped with a power supply cord that would carry power from the AC outlet to the AC/DC converter. The AC/DC circuit will then convert AC power to DC to run the motor in the power tool for example. Other embodiments may comprise of a wall mountable plug-in AC/DC converter, a power supply cord, and a power interface adapter shaped as a battery casing. Here the AC/DC power converter is located in the wall-plug rather than the power interface adapter.

As used herein and as is commonly known in the art, cordless power tools generally refer to electrical power tools that use rechargeable batteries. Examples of cordless power tools include, but are not limited to drills, hammer drills, drivers, saws, rotary tools, vacuums, flashlights, cutters, nailers, and sanders for example. Alternating current may refer to the form of electric power delivered to businesses and residences, and may have a frequency of 50 or 60 Hertz, and may commonly have a potential of 120 or 220-240 volts. Direct current may refer to current having a generally one directional flow of charge.

The replaceable battery pack as used herein and is commonly known in the art generally refers to a group of one or more battery cells electrically connected together and contained within a housing having electrical contacts which provide current to a cordless power tool. The battery packs may rely on nickel-cadmium or lithium-ion technologies and may be available as 7.2, 12, 18, 24, 28, and 36 volt battery packs. The battery pack housing may be shaped to be received and engaged by a cordless power tool. The battery pack may engage with a cordless power tool at the bottom of a handle grip of a cordless drill for example, or the battery pack may engage with the cordless tool at the side of the tool. The shape of the battery pack generally varies with the manufacturer, but many battery packs may have a curved, generally rectangular prismatic shaped base having a length and a width perpendicular to the direction of insertion into the cordless power tool. Some battery packs may have a protrusion extending above the base along the height of the battery pack. The lengths and widths of the battery pack may be in the range of approximately 2 inches to approximately 6 inches. The height of the battery pack may be in the range from approximately 3 inches to approximately 6 inches for battery packs having a protrusion. The height may be in the range of approximately 2 inches to approximately 4 inches for battery packs without a protrusion.

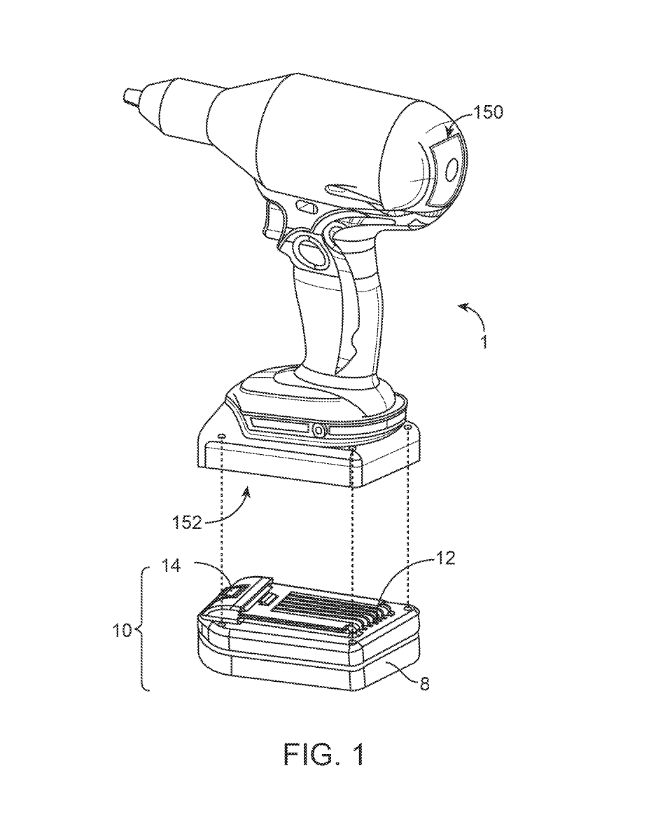

FIG. 1 is an exploded view of an exemplary cordless power tool system 1. The cordless power tool system 1 includes a power tool 150 and a replaceable battery pack 10. The battery pack 10 has a housing 8 which includes a mating tab 14. The housing 8 also has one or more electrical connectors 12 which are connected to one or more electric cells (not shown) providing direct current. The power tool 150 has a battery pack receiving cavity 152 which may be inversely shaped to that of the housing 8. A user aligns the battery pack 10 with the receiving cavity 152 on the power tool 150, and places the battery pack 10 into the receiving cavity 152 such that one or more mounting mechanisms such as tab 14 secures the battery pack 10 into the receiving cavity 152. A portion of the cordless power tool 150 may at least partially surround the battery pack 10 when the battery pack 10 is mated with the cordless power tool 150. The receiving cavity 152 has electrical contacts which mate with the electrical connectors 12 to provide direct current to the power tool 150. When the battery pack 10 has drained, the user may readily remove the battery pack 10 from the power tool 150 and replace the battery pack 10 with a fully-charged battery pack.

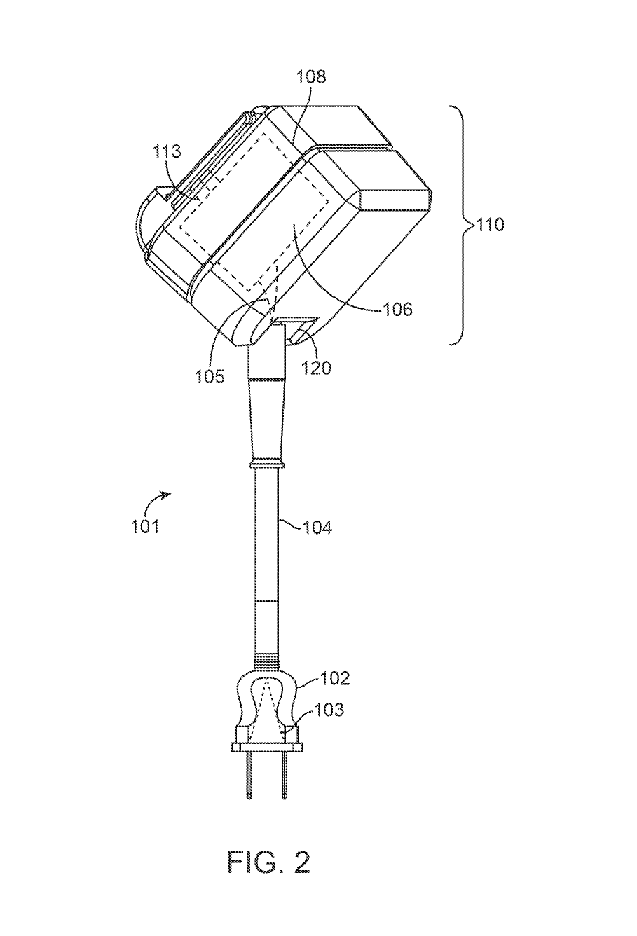

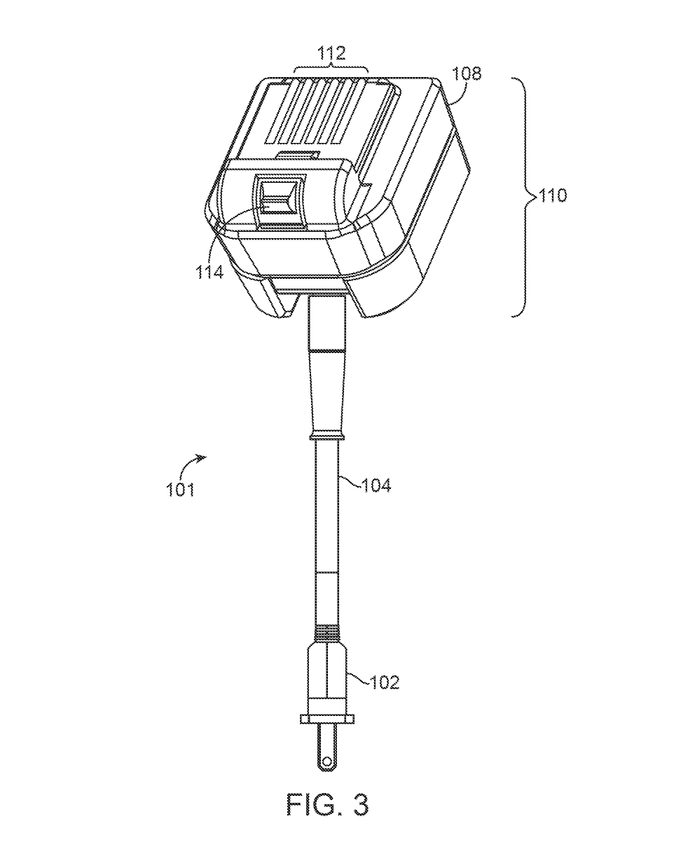

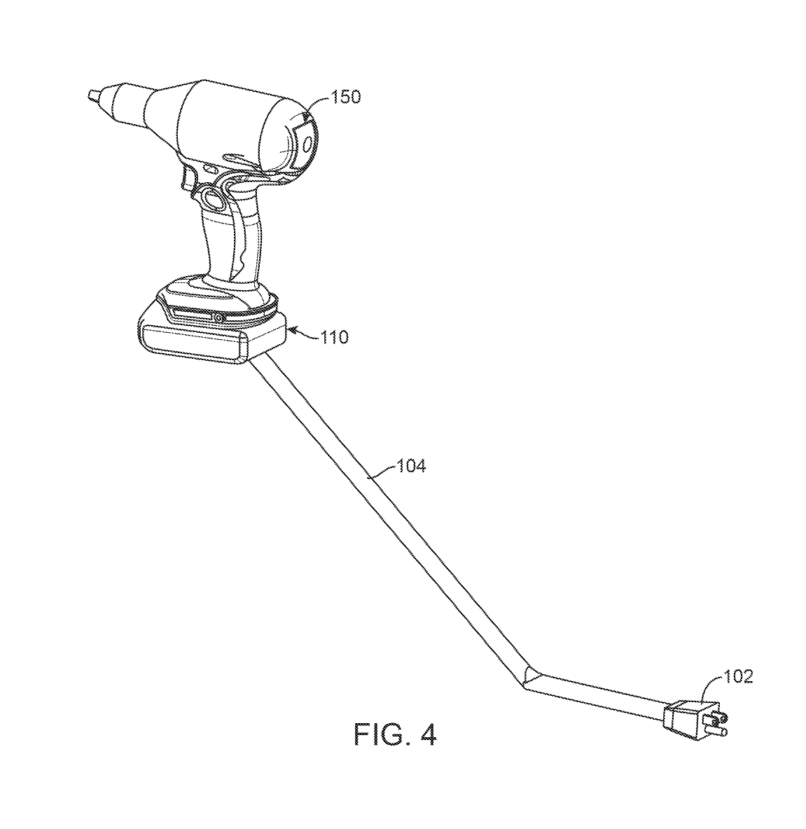

FIGS. 2 and 3 are perspective views of an electrical power assembly 101 having a power interface adapter 110 with an internal AC-DC converter 106 depicted by dashed lines in FIG. 2. FIG. 4 is a side, perspective vive of a cordless power tool 150 coupled with the electrical power assembly 101 depicted in FIGS. 2 and 3.

In an embodiment, the electrical power assembly 101 may comprise an AC electrical connector 102 coupled to an alternating current source, a power cord 104, and the power interface adapter 110. The AC electrical connector 102 receives alternating current from an alternating current source. The power cord 104 is connected to the AC electrical connector 102 via wires 103. The power cord 104 is also connected to the AC/DC converter 106 via wires 105. The AC/DC power converter 106 may comprise a switching power source and/or a transformer in one or more embodiments. In an embodiment, the power cord 104 may be coupled to the power interface adapter 110 via a swivel connector 120. The AC/DC power converter 106 receives alternating current and generates direct current to the electrical connections 112 via wires 113 for example.

The power interface adapter 110 is configured for mating with and powering a cordless power tool 150. The power interface adapter 110 may have one or more electrical connectors 112 coupled to the AC/DC power converter 106 which supplies direct current to the cordless power tool 150. The power interface adapter 110 also has a housing 108 which surrounds the AC/DC power converter 106 and exposes one or more of the electrical connectors 112 which provide electrical contact to the cordless power tool 150.

In one or more embodiments, the power interface adapter 110 has similar features and shape as that of the replaceable battery pack 10 shown in FIG. 1. Hence, in one or more embodiments, the power interface adapter 110 mates with the cordless power tool 150 in substantially the same manner as the replaceable battery pack 10 mates with the cordless power tool 150. For example, the power interface adapter 110 may have a shape and contour which allows the power interface adapter 101 to be received in the battery pack receiving cavity 152 in much the same manner as the replacement battery pack 10 is received in the receiving cavity 152. The power interface adapter 110 may have mechanical mounting mechanisms such as tab 114 which corresponds to the tab 14 in the replaceable battery pack 10. Moreover, the power interface adapter 110 may have electrical connectors 112 similar to the electrical connectors 12 in the battery pack 10. A portion of the cordless power tool 150 may at least partially surround the power interface adapter 110 when the power interface adapter 101 is mated with the cordless power tool 150.

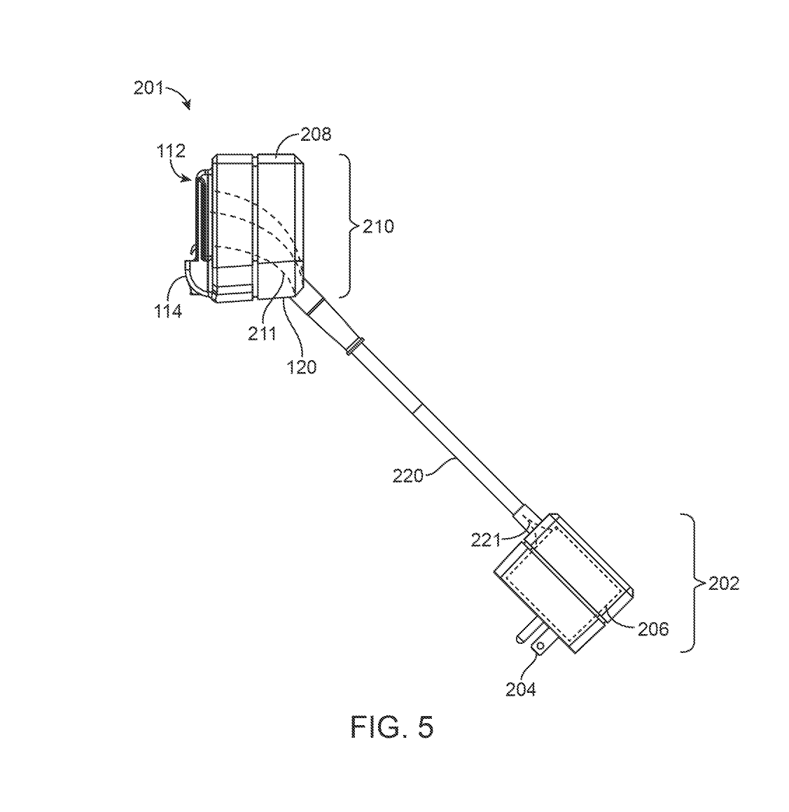

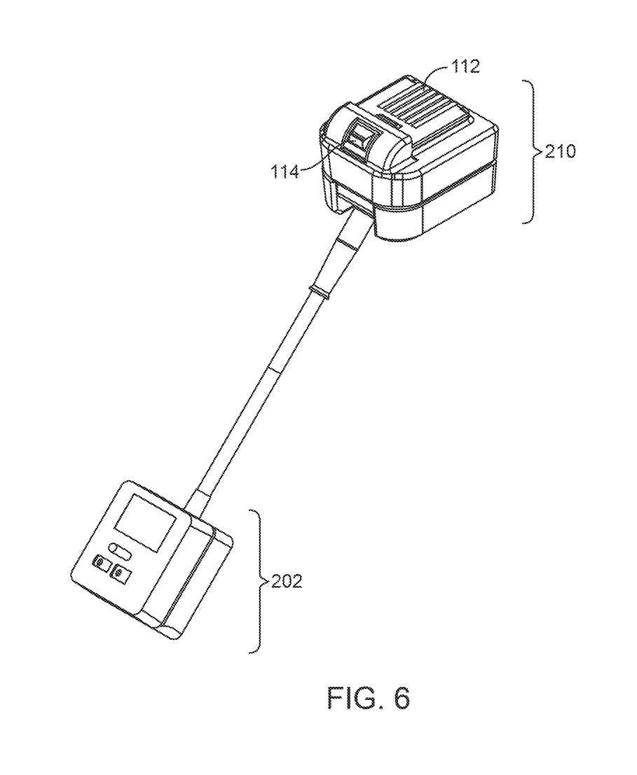

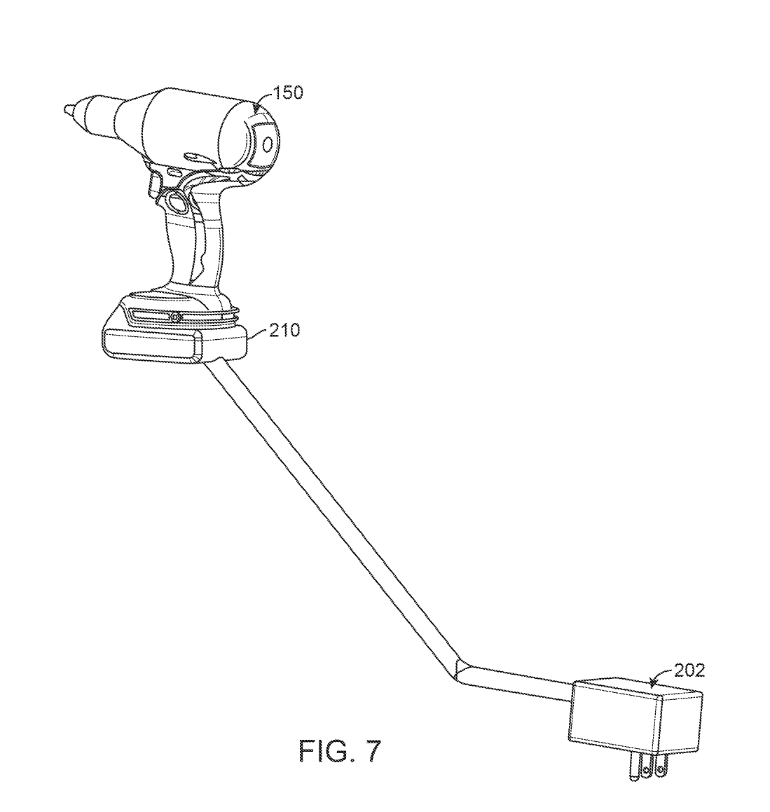

FIGS. 5 and 6 are views of an electrical power assembly 201 where the AC-DC converter 206 is located within a wall mountable electrical plug 202 in an embodiment. FIG. 7 is a side, perspective view of the cordless power tool 150 coupled with the electrical power assembly depicted in FIGS. 5 and 6.

In one or more embodiments, the electrical power assembly 201 may comprise a wall mountable electrical plug 202 coupled to an alternating current source via prongs 204, a power cord 220, and the power interface adapter 210. The wall mountable electrical plug 202 receives alternating current from an alternating current source. The wall mountable AC/DC power converter 202 has an AC/DC power converter 206 receiving alternating current and generating direct current. The AC/DC power converter 206 may comprise a switching power source and/or a transformer in one or more embodiments. The power cord 220 is connected to wall mountable electrical plug 202 via wires 221. The power cord 220 is also connected to power interface adapter 210 and direct current is delivered to the electrical connections 112 via wires 211. In an embodiment, the power cord 220 may be coupled to the power interface adapter 210 via a swivel connector 120.

The power interface adapter 210 is configured for mating with and powering a cordless power tool 150. The power interface adapter 210 may have one or more electrical connectors 112 coupled to the power cord 220 which supplies direct current to the cordless power tool 150. The power interface adapter 210 also has a housing 208 which surrounds the internal wiring 211 and exposes one or more electrical connectors 112 which provide electrical contact to the cordless power tool 150.

The power interface adapter 210 has similar features and shape as that of the replaceable battery pack 10 shown in FIG. 1. Hence, in one or more embodiments, the power interface adapter 210 mates with the cordless power tool 150 in substantially the same manner as the replaceable battery pack 10 mates with the cordless power tool 150. For example, the power interface adapter 210 may have a shape and contour which allows the power interface adapter 101 to be received in the battery pack receiving cavity 152 in much the same manner as the replacement battery pack 10 is received in the receiving cavity 152. The power interface adapter 210 may have mechanical mounting mechanisms such as tab 114 which corresponds to the tab 14 in the replaceable battery pack 10. Moreover, the power interface adapter 210 may have electrical connectors 112 similar to the electrical connectors 12 in the battery pack 10. A portion of the cordless power tool 150 may at least partially surround the power interface adapter 110 when the power interface adapter 101 is mated with the cordless power tool 150.

Although the invention has been discussed with reference to specific embodiments, it is apparent and should be understood that the concept can be otherwise embodied to achieve the advantages discussed. The preferred embodiments above have been described primarily as alternating current power interface adapters for powering cordless power tools. While the embodiments described above refer to an AC/DC power converter placed in the power interface adapter or in the wall mountable electrical plug, it shall be understood that other electrical circuits, components, or configurations are contemplated in one or more embodiments which receive alternating current from power sources and convert the alternating current to direct current for powering cordless power tools. In this regard, the foregoing description of the system and methods is present for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. An electrical power assembly for powering a cordless power tool, the cordless power tool configured for coupling to replaceable battery packs, the electrical power assembly comprising:
a power interface adapter configured for mating with and providing direct current to the cordless power tool, the power interface adapter further comprising:
an alternating current to direct current (“AC/DC”) power converter, the AC/DC power converter receiving alternating current and generating direct current;
one or more electrical connectors coupled to the AC/DC power converter and configured for supplying direct current to the cordless power tool; and,
a housing surrounding the AC/DC power converter and exposing the one or more electrical connectors for electrical contact to the cordless power tool.

2. The electrical power assembly for powering the cordless power tool of claim 1, further comprising:
an AC electrical connector for coupling to an alternating current power source and receiving alternating current; and,
a power cord connected to the AC electrical connector and AC/DC power converter, the power cord providing the alternating current to the AC/DC power converter.

3. The electrical power assembly for powering the cordless power tool of claim 1, wherein the power interface adapter mates with the cordless power tool in substantially the same manner as the replaceable battery pack mates with the cordless power tool.

4. The electrical power assembly for powering the cordless power tool of claim 1, wherein the shape of the power interface adapter is substantially similar to the shape of the battery pack.

5. The electrical power assembly for powering the cordless power tool of claim 1, wherein a portion of the cordless power tool at least partially surrounds the power interface adapter when the power interface adapter is mated with the cordless power tool.

6. The electrical power assembly for powering the cordless power tool of claim 1, wherein the AC/DC power converter comprises a switching power source.

7. The electrical power assembly for powering the cordless power tool of claim 1, wherein the AC/DC power converter comprises a transformer.

8. The electrical power assembly for powering the cordless power tool of claim 1, wherein power cord is coupled to the power interface adapter via a swivel connector.

9. An electrical power assembly for powering a cordless power tool, the cordless power tool configured for coupling to replaceable battery packs, the electrical power assembly comprising:
a wall mountable AC/DC power converter having integrated AC electrical connectors, the AC/DC power converter receiving alternating current and generating direct current;
a power cord connected to the AC/DC power converter, the power cord receiving direct current; and
a power interface adapter configured for mating with and providing direct current to the cordless power tool, the power interface adapter further comprising:
one or more electrical connectors coupled to the power cord and configured for supplying direct current to the cordless power tool; and,
a housing exposing the one or more electrical connectors for electrical contact to the cordless power tool.

10. The electrical power assembly for powering the cordless power tool of claim 9, wherein the power interface adapter mates with the cordless power tool in substantially the same manner as the battery pack mates with the cordless power tool.

11. The electrical power assembly for powering the cordless power tool of claim 9, wherein the shape of the power interface adapter is substantially similar to the shape of the battery pack.

12. The electrical power assembly for powering the cordless power tool of claim 9, wherein the cordless power tool at least partially surrounds the power interface adapter when the power interface adapter is mated with the cordless power tool.

13. The electrical power assembly for powering the cordless power tool of claim 9, wherein the AC/DC converter comprises a switching power source.

14. The electrical power assembly for powering the cordless power tool of claim 9, wherein the AC/DC converter comprises a transformer.

15. An electrical power assembly for powering a cordless power tool, the cordless power tool configured for coupling to replaceable battery packs, the electrical power assembly comprising:
an AC/DC power converter, the AC/DC power converter receiving alternating current and generating direct current; and,
a power interface adapter configured for mating with the cordless power tool, the power interface adapter receiving the direct current from the AC/DC power converter and powering the cordless power tool.

16. The electrical power assembly for powering the cordless power tool of claim 15, wherein the power interface adapter mates with the cordless power tool in substantially the same manner as the battery pack mates with the cordless power tool.

17. The electrical power assembly for powering the cordless power tool of claim 15, wherein the shape of the power interface adapter is substantially similar to the shape of the battery pack.

18. The electrical power assembly for powering the cordless power tool of claim 15, wherein the cordless power tool at least partially surrounds the power interface adapter when the power interface adapter is mated with the cordless power tool.

19. The electrical power assembly for powering the cordless power tool of claim 15, wherein the AC/DC converter comprises a switching power source.

20. The electrical power assembly for powering the cordless power tool of claim 15, wherein the AC/DC converter comprises a transformer.
